(19) United States
(12) Patent Application Publication
(10) Pub. No.: US 2010/0287787 A1
(43) Pub. Date: Nov. 18, 2010

(54) DEVICE AND METHOD FOR BREAKING CAKED GRAIN IN A STORAGE BIN

(75) Inventors: BRITT C. SHELTON, WOOLSTOCK, IA (US); NORM D. ANDERSON, WEBSTER CITY, IA (US); DARREL E. HAY, WEBSTER CITY, IA (US)

Correspondence Address: MCKEE, VOORHEES & SEASE, P.L.C., 801 GRAND AVENUE, SUITE 3200, DES MOINES, IA, 50309-2721, US

(73) Assignee: SHELTON/HAY LLC, WOOLSTOCK, IA (US)

(21) Appl. No.: 12/464,281

(22) Filed: May 12, 2009

(51) Int. Cl. F26B 9/08; F26B 25/08

(52) U.S. Cl. 34/387; 34/181

(57) ABSTRACT

A grain bin is provided with a pipe extending beneath the perforated floor through which drying air passes upwardly. A tool extends through the pipe to the central grain outlet opening in the floor. The tool includes a cutting or grinding head which can be rotated from outside the bin so as to break up grain blockages above the outlet opening. A cap may be provided on the inner end of the pipe to preclude grain from entering the pipe.

### FIELD OF THE INVENTION

This invention is directed to grain storage bins, and particularly to an apparatus and method for dislodging a grain blockage in the bin.

### BACKGROUND OF THE INVENTION

Circular storage bins for storing grain, such as corn, soybeans, and the like, are commonly used at farms and grain storage facilities. Grain is deposited into the top of the circular bin and then dried and stored for any length of time. The grain or beans are removed through the bottom of the storage bin by passing through a central discharge opening and into an auger residing beneath the perforated floor of the bin. The auger transports the grain out of the grain bin to a waiting transport vehicle.

During storage, air is forced upwardly through the perforated floor of the grain bin and percolates through the stored grain so as to dry the grain. However, as the air picks up moisture from the lower layers of stored grain, its ability to dry the higher layers of grain is reduced. As a result, there is often higher moisture content in the grain nearest the top of the storage bin. This higher moisture content enables smaller particles or fines to become compacted into a caked mass or plug, or increases the chance of rotting within the grain, the heat from which also tends to form a plug of caked grain. Because the outlet on the bottom of the grain bin is centrally located, there is less air which is blown through the center of the grain bin. As a result, these plugs tend to be formed within the center of the grain bin in the upper layers of the stored grain. Grain can also cake at lower levels if proper drying is not achieved.

As the grain is emptied from the storage bin through the centrally located discharge opening or outlet, these formed plugs tend to obstruct the flow of grain through the outlet. Eventually, one of these plugs will reach and block the outlet, significantly reducing or stopping the flow of grain through the outlet.

A variety of methods and apparatus have been developed to avoid such grain blockages, including caps positioned over the outlet to deflect plugs, additional outlets placed radially away from the centrally located outlet, and augers permanently installed within the storage bin to break up the caked grain.

There are disadvantages associated with each of these methods and apparatus. For example, caps may still become clogged, and only divert a plug. Additional openings tend to create an imbalance of grain within the storage container, potentially leading to the bin tipping or rupturing due to the pressure of the grain. Finally installed augers within the bin may themselves become clogged, or unable to break up plugs.

Accordingly, a primary objective of the present invention is the provision of an improved grain bin having an apparatus for breaking up caked grain.

Another objective of the present invention is the provision of a grain bin having a pipe extending beneath the perforated floor through which a tool can be inserted to break up grain blockages adjacent the grain discharge opening.

A further objective of the present invention is the provision of a grain bin retrofit with a pipe beneath the perforated floor through which a snake can be extended and rotated to cut up impacted grain plugs.

Still another objective of the present invention is the provision of an improved method of breaking up a grain blockage at the central discharge opening of a grain bin.

Still another objective of the present invention is the provision of a method of unclogging the central grain bin outlet using a flexible sewer snake.

Yet another objective of the present invention is a device that can be retrofit onto existing grain bins to facilitate the break up of caked grain in the bin.

Another objective of the present invention is the provision of a device and method for breaking up a grain blockage in a grain bin which is economical and effective.

These and other objectives will become apparent from the following description of the invention.

### SUMMARY OF THE INVENTION

The invention generally consists of a method and apparatus for breaking caked grain plugs or blockages adjacent the central grain outlet of a grain bin.

More specifically, the invention relates to a pipe or other conduit passing beneath the perforated floor of a grain bin from a point on the outer perimeter of the grain bin to the center of the grain bin adjacent the discharge opening. A flexible tool is inserted through the pipe and emerges inside the grain bin adjacent the outlet. The tool is then rotated, causing the head of the tool to cut, grind or otherwise break up the plug.

According to a further aspect of the invention, the pipe or conduit includes a cap or lid which selectively allows passage of all or part of the flexible tool while prohibiting grain from entering the pipe.

According to a further aspect of the invention, the pipe or conduit intersect the center grain outlet of the grain bin, thereby ensuring that the flexible tool engages the plug or blockage.

### BRIEF DESCRIPTION OF THE DRAWINGS

FIG. 1 is a cutaway view of a grain bin with a grain plug adjacent the top of the bin.

FIG. 2 is an enlarged cutaway view of the lower end of the grain bin with a grain plug adjacent the center discharge opening.

FIG. 3 is a further enlarged view of the preferred embodiment of the invention.

### DETAILED DESCRIPTION OF THE PREFERRED EMBODIMENT

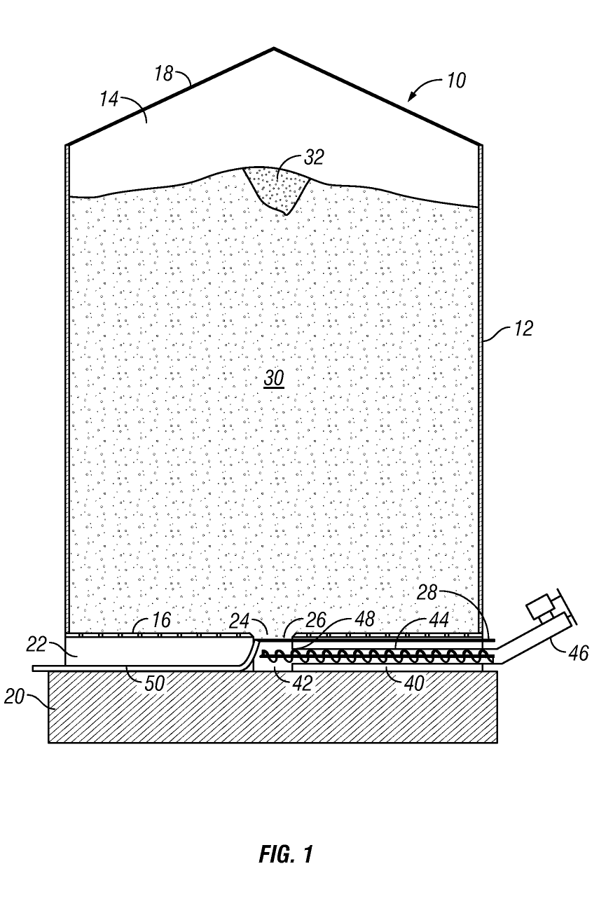

The invention is generally shown in FIG. 1. As shown, a conventional grain bin 10 is normally constructed on top of a concrete base or pad 20 for storing grain 30. The bin 10 includes an outer wall 12 defining an enclosure 14 with a perforated floor 16 and a roof or cap 18. The grain 30 is deposited through an inlet (not shown) in the roof 18. The perforated floor 16 allows air to pass upwardly through the grain 30 while restricting grain 30 from passing downwardly through the floor 16. The floor 16 is spaced above the concrete slab 20 so as to define a cavity 22, through which the drying air is blown for upward percolation in order to dry the grain 30. Also included in the cavity 22 are a number of supports (not shown) for holding the drying floor 16 of the grain bin 10 in spaced relation above the concrete pad 20. The floor 16 includes a central discharge opening 24 and a sliding gate 26 to open and close the opening 24.

Within the cavity 22 is an auger system 40 which includes a sump or inlet portion 42 and a screw portion 44. When the grain 30 is to be withdrawn from the grain bin 10, the gate 26 in the drying floor 16 is opened, thereby allowing the grain 30 to flow into the opening or outlet 24 and into the sump 42. The gate 26 is opened by means of a handle 28 which is connected to the gate 26 by mechanical, electrical, hydraulic, or other conventional means. The grain 30 is then transported by means of the auger or screw 44 from the sump 42 to an unloader 46 where it is collected by a truck or other vehicle for transport offsite.

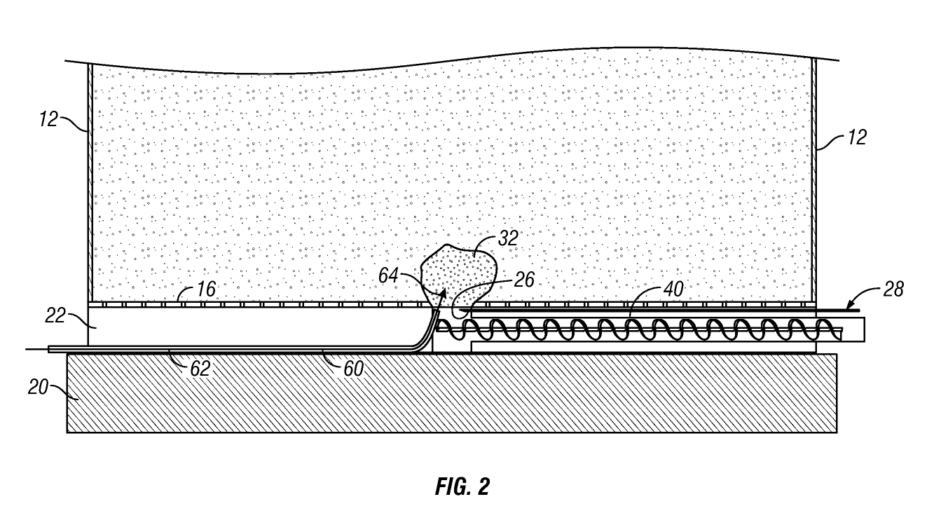

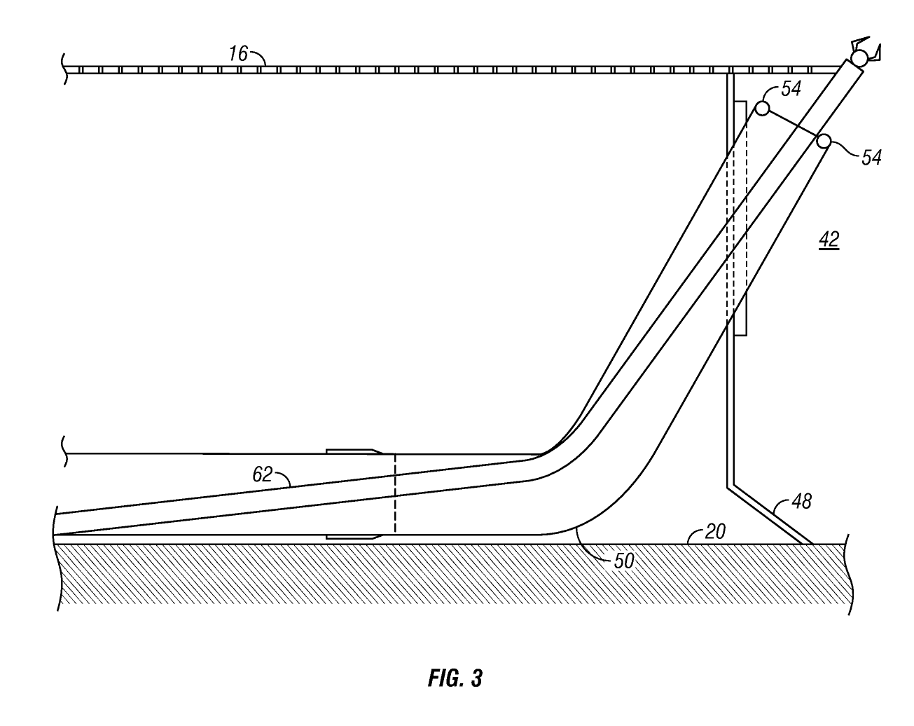

The present invention is directed to an improvement for the grain bin 10, or other grain bins having a central sump for removal of grain. More particularly, a pipe 50 or other conduit located within the cavity 22 extends from the outer edge of the grain bin 16 to the discharge outlet 24 adjacent the sump 42 of the auger 40. The pipe 50 is sized to admit a flexible tool 60 (see FIGS. 2 and 3), such as a pipe snake or sewer snake, and hereafter referred to simply as a snake. The snake 60 comprises a flexible body portion 62 and a cutting head portion 64 having a bit or sharpened end which may be twisted or turned about a radius so as to be slidably moved through the pipe 50. The outer end of the body 62 has a handle (not shown) which may be rotated by hand or by power means, such as a drill or motor. The body 62 is of sufficient rigidity so that as the handle is rotated, this rotational movement is communicated along the length of the body 62 to the head 64, which cuts or grinds into a caked mass or grain plug 32. The tool 60 is similar to a plumbing snake commonly used in plumbing to dislodge clogs from drains in pipes.

In order to prevent grain 30 from falling into the pipe 50, a cap 52 may be included. The cap 52 may take one of several forms. For example, the cap 52 may have a hole therethrough for the body 62 to slide through, without allowing the head 64 of the tool 60 to be pulled rearwardly into the pipe 50. According to this arrangement, the head 64 remains outside of the pipe 50 and the snake 60 cannot be removed by backing it through the pipe 50. In an alternative design the cap 52 has a number of flaps or tabs which allow the head 64 of the snake to be pushed or pulled through the cap. The tabs are of sufficient rigidity that the pressure of the grain 30 does not force the tabs apart, thereby precluding grain 30 from entering the pipe 50. Other cap structures may also be used to keep grain out of the pipe 50, without departing from the scope of the invention.

In the preferred embodiment, the pipe 50 is approximately 2″ in diameter and may have multiple sections joined together by flaring one end of a section of pipe and fitting the end of another section into the flared space. This method is well known in the automotive industry for forming an airtight junction between two lengths of pipe. The pipe 50 preferably enters the cavity 22 parallel to and against the concrete slab 20 before bending at approximately 55-65° upwards towards the perforated floor 16. The snake 60 is preferably of a diameter of ⅝″ allowing the snake 60 to easily pass through the 2″ pipe 50 while having sufficient strength to break up grain plugs 32. Also included at the inner end of the pipe 50 is a radius 54 formed about the normally sharp end of the pipe 50. This radius 54 prevents wear on the snake 60 due to the sharp edge and provides a radius about which the body 62 can be bent. The radius is formed by turning out the edge of the pipe, welding a length of tubing (e.g. ¼″ diameter) to the inside of the pipe, or other means commonly known in the art.

While it is generally shown that the pipe 50 extends in a direction away from the auger 40, this is not necessarily required and the position of the pipe 50 relative the auger 40 may vary. The position of the pipe 50 is determined by available space in the cavity 22 as the pipe must be positioned so as to by-pass the supports for the floor 16. However, as an alternative to the drawings, the pipe 50 may reside adjacent the auger 40 or any other location wherein the pipe 50 is easily accessible to an operator.

The present invention also includes a method for removing clogs from a grain bin 10. Once a plug 32 has been detected, as evidenced by a significant reduction or blockage of grain flow, a snake 60 is inserted through the pipe 50 and into the grain bin 10 through the opening 24. Once the snake head 64 has contacted the plug 32, the snake body 62 is rotated and the head 64 cuts or grinds into the plug 32, thereby breaking the plug into smaller pieces for transport by the auger 40. If grain flow does not commence, the snake body 62 is rotated in the opposite direction to reposition the snake head 64 to another point on the plug 32, and the body 62 is once again rotated to drive the head 64 of the snake 60 into cutting or grinding engagement with the plug 32. This process is repeated as often as required to break up the plug 32.

As will be understood by the foregoing description, it will be apparent that various changes may be made in the form, construction and arrangement of the components of the invention, as shown and described, without departing from the scope and spirit of the invention, or without sacrificing all of its material advantages. The form herein described is merely exemplary embodiments of the invention.

What is claimed is:

1. An improved grain bin having an outer wall, a base, and a ceiling, a raised floor above the base defining a cavity between the floor and the base, the floor having a plurality of perforations therein sized to allow air to pass upwardly through and prohibiting grain from passing downwardly, a discharge opening through the perforated floor allowing grain to pass downwardly into an unloading system within the cavity for transporting grain from the opening to a location outside the bin, the improvement comprising:
a tool slidably and rotatably extending through the cavity and the discharge opening to dislodge grain caked in the bin.

2. The grain bin of claim 1 further comprising a pipe extending through the cavity and through which the tool slidably extends.

3. The grain bin of claim 2 wherein the pipe includes an outer end and an inner end, the inner end having a radius so as to minimize wear of the tool.

4. The grain bin of claim 2 wherein the pipe has an inner end adjacent the discharge opening.

5. The grain bin of claim 2 wherein the pipe includes a cap to prevent grain from entering the pipe when the tool is not in use.

6. The grain bin of claim 5 wherein the cap comprises a flexible material to selectively allow the tool to pass through while inhibiting grain from passing through.

7. The grain bin of claim 2 wherein the pipe has an inner end extending upwardly to direct the tool into the bin.

8. The grain bin of claim 1 wherein the tool includes an elongated rotatable body with an external end adapted to be connected to a rotating drive member and an inner end adapted to break up the caked grain.

9. The grain bin of claim 8 wherein the inner end of the tool has a head to cut or grind the caked grain.

10. The grain bin of claim 1 wherein the tool comprises a flexible body and a head portion attached to the body.

11. A method of breaking a grain blockage in a grain bin, the grain bin having a perforated floor to support grain in the bin and through which drying air passes upwardly, a cavity beneath the perforated floor, a discharge opening through the perforated floor, and an auger within the cavity with an inlet and adjacent the opening to receive and transport grain from the grain bin, the method comprising:
extending a tool beneath the floor, into the discharge opening, and upwardly above the floor for contact with the grain; and
rotating the tool to break up a grain blockage above the floor.

12. The method of claim 11 wherein the tool rotates within a pipe extending from a perimeter wall of the grain bin to the discharge opening.

13. The method of claim 12 further comprising sliding the tool through the pipe for positioning into and out of the grain.

14. The method of claim 11 wherein the tool is manually rotated.

15. The method of claim 11 wherein the tool is rotated by a motor.

16. The method of claim 11 wherein the tool is rotated by a drill.

17. The method of claim 11 wherein rotation of the tool cuts the blockage.

18. The method of claim 11 wherein rotation of the tool grinds the blockage.

19. A grain bin comprising:
a perforated floor through which drying air passes upwardly;
a grain outlet in the floor; and
a tool extending beneath the floor and having an outer drive end and an inner end extending upwardly through the outlet to break up grain blockages above the outlet.

20. The grain bin of claim 19 further comprising a pipe beneath the floor through which the tool rotatably and slidably extends.
